(19) United States
(12) Patent Application Publication
(10) Pub. No.: US 2009/0098773 A1
(43) Pub. Date: Apr. 16, 2009

(54) SPACE MINIMIZED FLASH DRIVE

(75) Inventors: CHIH-CHIEN CHENG, Kaohsiung (TW); TSE-MING LIN, Kaohsiung (TW)

Correspondence Address: Yen Jung Sung, 21-80 38 St, #C8, Astoria, NY, 11105, US

(73) Assignee: Walton Advanced Engineering, Inc, Kaohsiung (TW)

(21) Appl. No.: 12/325,186

(22) Filed: Nov. 29, 2008

(30) Foreign Application Priority Data
Apr. 16, 2007 (TW) 097206516

(51) Int. Cl. H01R 13/648

(52) U.S. Cl. 439/607.22

(57) ABSTRACT

A space-minimized flash drive has a USB connector and a body, where the flash drive comprises a printed circuit board, a plurality of contact fingers, one or more memory devices, and a controller. The printed circuit board has a component section located inside the body and an insertion section extending into and located inside the USB connector. The memory device is disposed on the component section. The contact fingers are disposed on the top surface of the insertion section. The controller is disposed on the bottom surface of the insertion section located inside the USB connector. The footprint occupied by the controller and the corresponding empty footprint are saved to effectively reduce the length of the flash drive to miniaturize flash drives without interfering with the electrical connections of the contact fingers when plugging in the flash drive.

### FIELD OF THE INVENTION

The present invention relates to a miniature semiconductor storage device, and more particularly to a space-minimized flash drive.

### BACKGROUND OF THE INVENTION

Flash drives normally have USB connectors to plug into USB sockets of electronic devices for data storage and access. USB stands for “Universal Serial Bus” and is an international connector standard. USB provides multiple advantages for end users, such as ease of use, expandability, and high data transfer rates, and therefore the USB standard has been widely implemented in various electronic devices, computers, IA, and 3C consumer products and has become a necessity in everyday lives.

The USB connector is located at the front end of a flash drive and is formed by a rectangular metal case with a plastic insulator, where four USB contact fingers are disposed on the surface of the plastic insulator. The plastic insulator is formed from a solid resin material on a rigid substrate, such as white ceramic, black plastic, or other rigid substrates, to firmly hold and carry the USB contact fingers.

A conventional flash drive not only has a USB connector but also has a rectangular body where a plurality of components such as flash memory devices, controllers, and passive components are disposed on a printed circuit board enclosed by the rectangular body. The USB connector is soldered to the printed circuit board. In an existing structure, the dimensions of the controllers or passive components are smaller than those of the memory devices, leaving some empty footprints on the printed circuit board that are not utilized. Based upon the footprint of the memory devices, controllers, and passive components on the printed circuit board, and in particular the empty footprint that can not be utilized, the length of the rectangular body is normally 2.5 times greater than that of the USB connector.

In a conventional miniature USB flash drive, memory devices and controllers in chip forms are disposed using COB (Chip-On-Board) processes where only memory devices are directly disposed on the printed circuit board. An RDL (Redistribution Layer) is disposed on the active surfaces of memory chips to stack controllers and passive components on the memory devices in chip forms. Then, stacked controllers and passive components are electrically connected to a printed circuit board via RDL. Although RDL is fabricated during the IC fabrication of memory devices in wafer form, the chip design is complicated and increases costs. When two different memory devices in chip forms are needed in a conventional USB flash drive, one with RDL and the other without RDL, increasing the complexity of chip management. Moreover, once the design of RDL is finalized, then the dimensions of controllers and passive components in chip forms are also fixed, and thus multiple sources of controllers and passive components cannot easily be found at lower prices, leading to a reduced selection of controllers and passive components in the market and higher manufacturing costs and difficulties.

### SUMMARY OF THE INVENTION

The main purpose of the present invention is to provide a space-minimized flash drive to effectively reduce the length of the flash drive to miniaturize the flash drive without greatly increasing the manufacturing costs during mass production.

According to the present invention, a space-minimized flash drive has a USB connector and a body where the flash drive comprises a printed circuit board, a plurality of contact fingers, a first memory device, and a controller. The printed circuit board has a component section located inside the body and an insertion section extending into and located inside the USB connector. The contact fingers are disposed on the top surface of the insertion section and a first memory device is disposed on the component section. The controller is disposed on the bottom surface of the insertion section located inside the USB connector.

The space-minimized flash drive according to the present invention has the following advantages and functions:

1. The footprint occupied by controllers and the empty footprint on the printed circuit board of the USB flash drive can be saved to effectively reduce the length of the flash drive without interfering with the electrical connections of the contact fingers when plugging in the flash drive. In a more specific structure, the length of a USB flash drive can be controlled to be under 2.5 times the one of a USB connector.

2. Memory devices can be disposed on both top and bottom surfaces of a printed circuit board to effectively reduce the length of a flash drive to meet miniaturization requirements without requiring RDL on the active surfaces of memory chips to greatly reduce manufacturing costs in mass production.

3. The manufacturing processes becomes easy with SMT memory devices and controllers on the same surface of a printed circuit board.

4. The component section and the insertion section of a printed circuit board can be formed in the same body at the same time without the conventional soldering processes to effectively reduce cycle times and cost.

5. The board strengths of a printed circuit board can be increased to avoid damages of controllers when plugging in the USB flash drive.

6. The passive components are disposed inside the flash drive to reduce both the component footprint and the empty space footprint.

### DESCRIPTION OF THE DRAWINGS

FIG. 1 is a perspective view of a space-minimized flash drive according to the first embodiment of the present invention.

FIG. 2 is a cross-sectional view of a space-minimized flash drive according to a first embodiment of the present invention.

FIG. 3 is a top view of a printed circuit board of a space-minimized flash drive according to the first embodiment of the present invention.

FIG. 4 is a bottom view of a printed circuit board of a space-minimized flash drive according to the first embodiment of the present invention.

FIG. 5 is a bottom view of a printed circuit board of a space-minimized flash drive showing the position of a first memory device and a controller according to the first embodiment of the present invention.

FIG. 6 is a cross-sectional view of a space-minimized flash drive according to a second embodiment of the present invention.

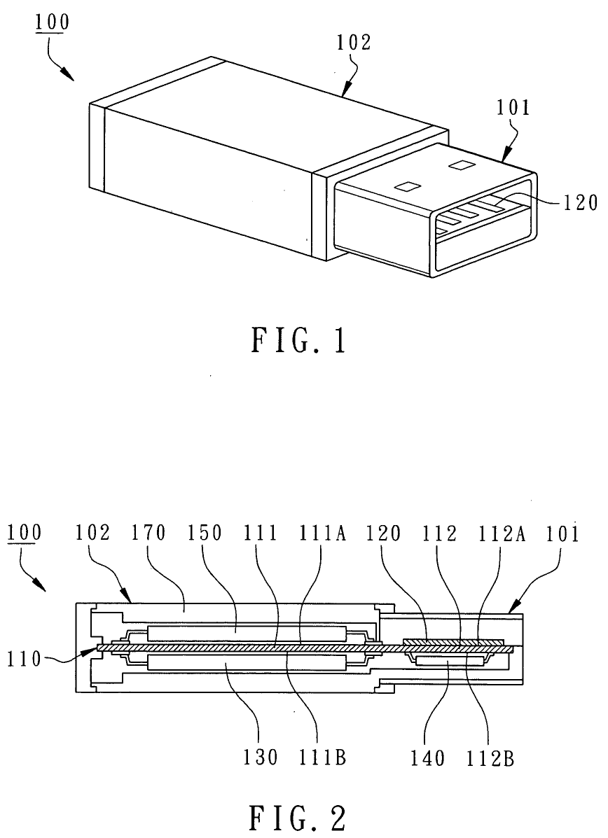

### DETAILED DESCRIPTION OF THE INVENTION

With reference to the attached drawings, the present invention is described by means of the embodiment(s) below.

According to a first embodiment of the present invention, a space-minimized flash drive 100 has a USB connector 101 and a body 102 where the USB connector 101 is a relatively square metal case disposed at the front end of the body 102. More specifically, the USB connector 101 is a standard A-type USB connector which can be inserted into a USB socket of a primary system, such as a personal computer, where data can be accessed and stored through the USB connector 101.

As shown in FIG. 2, the flash drive 100 primarily comprises a printed circuit board 110, a plurality of contact fingers 120, a first memory device 130, and a controller 140.

As shown in FIG. 2, the printed circuit board 110 has a component section 111 located inside the body 102 and an insertion section 112 extending into and located inside the USB connector 101. Typically the printed circuit board 110 is a high-density double-sided multi-layer printed circuit board with internal traces as electrical transferring media. The component section 111 and the insertion section 112 are formed in a body to eliminate conventional soldering processes, effectively reducing the manufacturing time and costs and increasing the board strength to enhance the electrical connections between components as well as the durability of the flash drive 100.

As shown in FIG. 2 and FIG. 3, the contact fingers 120 are disposed on the top surface 112A of the insertion section 112; the contact fingers 120 are also known as “gold fingers”. As shown in FIG. 3, the number of contact fingers 120 is normally four, including a VCC power trace, a GND ground trace, a D+ data transfer trace, and a D− data transfer trace, in which the D+ data transfer trace and the D− data transfer trace are used for the transfer of data. The VCC trace and the GND trace accept operating voltages and currents from another power source or from another USB drive. The contact fingers 120 are designed and arranged according to USB standards.

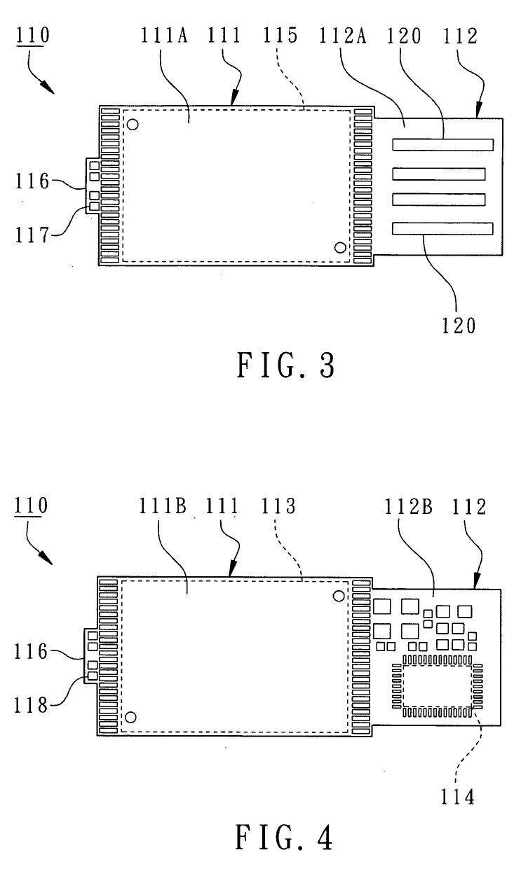

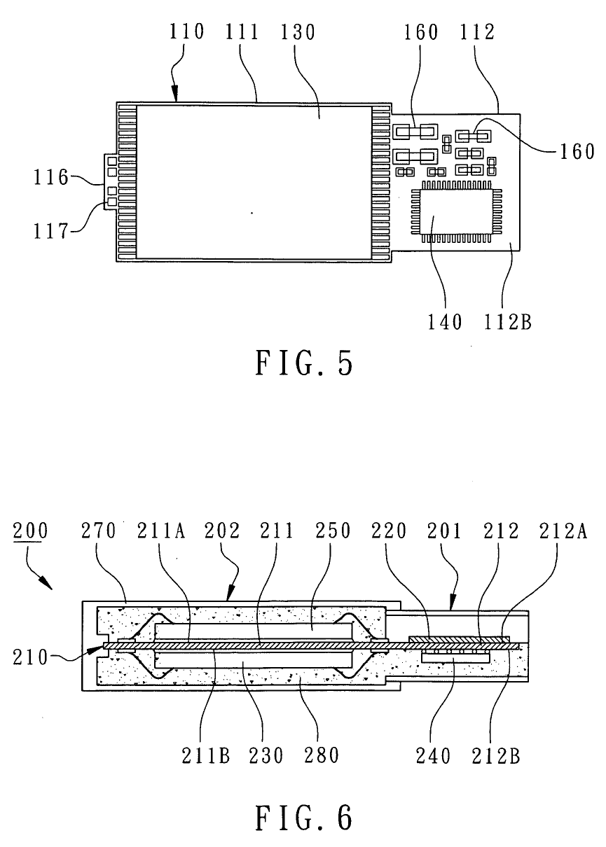

As shown in FIG. 2 and FIG. 5, the first memory device 130 is disposed on the component section 111. In the present embodiment, as shown in FIG. 4, the bottom surface 111B of the component section 111 comprises a covered area 113 for accepting the first memory device 130. More specifically, the dimensions of the footprint of the first memory device 130, i.e., the covered area 113, is approximately equal to the component section 111, and therefore the component section 111 of the printed circuit board 110, i.e., the body 102, does not have any empty footprint after component placement to miniaturize the flash drive. In the present embodiment, the first memory device 130 is a semiconductor package assembled with a flash memory chip, which is a non-volatile memory and does not lose the stored data due to power loss. Referring back to FIG. 2, the first memory device 130 can be a TSOP having a plurality of external leads extended from two opposing sides of an encapsulant, which can be disposed on the component section 111 by way of SMT.

Furthermore, as shown in FIG. 2 and FIG. 4, the controller 140 is disposed on the bottom surface 112B of the insertion section 112 located inside the USB connector 101. More specifically, a covered area 114 is defined on the bottom surface 112B of the insertion section 112 to accept the controller 140, where the dimensions of the covered area 114 are approximately equal to those of the controller 140. This kind of layout is beneficial to manufacture shorter and smaller miniaturized flash drives 100 with less design variables and lower costs.

More specifically, as shown in FIG. 4 and FIG. 5, the footprint of the controller 140, i.e., the covered area 114, can be smaller than that of the first memory device, i.e., the covered area 113. The controller 140 can be disposed by way of SMT or by COB inside the USB connector 101 without interfering with the electrical connections of the contact fingers 120 when plugging in the flash drive 100. Therefore, there is no need to dispose a controller 140 on the component section 111 in the body 102 as with a conventional flash drive, thus saving the footprint occupied by a controller and the corresponding empty footprint.

Preferably, as shown in FIG. 2, the first memory device 130 can be disposed on the bottom surface 111B of the component section 111 on the same surface as the controller 140 where the first memory device 130 and the controller 140 are disposed by way of SMT for ease of manufacturing. Furthermore, the controller 140 is electrically connected to the first memory device 130 and to the contact fingers 120 through the metal circuitry (not shown in the figures) of the printed circuit board 110.

More specifically, as shown in FIG. 2, the flash drive 100 further comprises a second memory device 150 disposed on the top surface 111A of the component section 111 corresponding to the covered area 115 on the top surface 111A of the component section 111, as shown in FIG. 3. Therefore, the first memory device 130 and the second memory device 150 are respectively disposed on the bottom surface 111B and the top surface 111A of the component section 111 to effectively utilize the top and bottom surfaces of the component section 111 of the printed circuit board 110 and to effectively reduce the dimensions of the body 102 of the flash drive 100 having higher memory capacities. Furthermore, there is no need for RDL disposed on memory chips without greatly increasing the manufacturing costs. As shown in FIG. 2, in the present embodiment, the second memory device 150 is also a TSOP.

Moreover, as shown in FIG. 3 and FIG. 4, an extruded portion 116 is formed on one side of the component section of the printed circuit board opposite to the corresponding insertion section 112 where a plurality of metal pads 117 and 118 are disposed on the extruded portion 116 for disposing an indicating light, not shown in the figure. Preferable, the indicating light is an LED chip to maximally conserve space. More specifically, the metal pads 117 are disposed on the top surface 111A of the component section 111 and the metal pads 118 are disposed on the bottom surface 111B of the component section 111 and the LED chip disposed on the metal pads 117 and 118 can emit different colors, such as red or green, to display the status of the flash drive 100 during power up or during data accessing.

As shown in FIG. 2 and FIG. 5, the flash drive 100 further includes one or more passive component 160 such as resistors, inductors, or capacitors disposed on the bottom surface 112B of the insertion section 112 located inside the USB connector 101 without disposing the passive components 160 in the body 102 nor on the chip, which effectively utilizes the bottom surface 112B of the insertion section 112 to further shrink the length of the flash drive to save even more space.

Furthermore, as shown in FIG. 2, the flash drive 100 further comprises a shell 170 to enclose and protect the first memory device 130, the second memory device 150, and the printed circuit board 110. The shell 170 is attached to portions of the USB connector 101 to expose the USB connector 101. To be more specific, the shell 170 can be made of different non-metallic materials, such as plastic, ABS, or polymers, to provide different appearances of the flash drive 100 and to lower manufacturing costs. When plastic is selected, since plastic is cheaper than metal, the cost of raw materials can be effectively reduced. Moreover, plastic is lighter than metal to provide a flash drive with less weight. The different appearances can be designed to meet the preferences and needs of end users that purchase the flash drives.

In a second embodiment of the present invention, as shown in FIG. 6, another space-minimized flash drive 200 is shown having a USB connector 201 and a body 202. The flash drive 200 primarily comprises a printed circuit board 210, a plurality of contact fingers 220, a first memory device 230, a controller 240, and a second memory device 250, in which the printed circuit board 210 has a component section 211 located inside the body 202 and an insertion section 212 extended into the USB connector 201. The contact fingers 220 are disposed on the top surface 212A of the insertion section 212.

As shown in FIG. 6, in the present embodiment, a first memory device 230 and a second memory device 250 are flash memories and are respectively disposed on the bottom surface 211B and the corresponding top surface 211A of the component section 211 of the printed circuit board 210 by way of COB processes and are electrically connected to the printed circuit board through wire bonding. Additionally, the controller 240 is a semiconductor chip disposed on the bottom surface 212B of the insertion section 212 of the printed circuit board 210 located inside the USB connector 210 by way of a flip chip process. Therefore, the footprints occupied by the controller and the corresponding empty footprint as in a conventional flash drive are saved without interfering with the electrical connections of the contact fingers 220 when plugging in the flash drive 200.

More specifically, as shown in FIG. 6, in the present embodiment, the flash drive 200 further comprises an encapsulant 280 formed on the bottom surface 211B of the component section 211 and on the bottom surface 212B of the insertion section 212 to encapsulate the first memory device 230 and the controller 240 to increase the board strength of the printed circuit board 210 to avoid damages of the controller 240 when plugging in the flash drive 200. Specifically, the encapsulant 280 is further disposed on the top surface 211A of the component section 211 to encapsulate the second memory device 250 with the contact fingers 220 exposed for data access purposes.

After encapsulation, a shell 270 is provided to enclose the encapsulant 280 and provide the external protection of the flash drive 200. The shell 270 can be made from different non-metallic materials, such as plastic, ABS, or polymers to achieve different appearances of the flash drive 200 and to lower manufacturing costs.

The above description of embodiments of this invention is intended to be illustrative but not limiting. Other embodiments of this invention will be obvious to those skilled in the art in view of the above disclosure.

What is claimed is:

1. A space-minimized flash drive having a USB connector and a body, the flash drive comprising:
a printed circuit board having a component section inside the body and an insertion section extending into the USB connector;
a plurality of contact fingers disposed on a top surface of the insertion section;
a first memory device disposed on the component section; and
a controller disposed on a bottom surface of the insertion section located inside the USB connector.

2. The flash drive as claimed in claim 1, wherein a footprint of the controller is smaller than that of the first memory device.

3. The flash drive as claimed in claim 1, wherein a footprint of the first memory device is approximately equal to the component section.

4. The flash drive as claimed in claim 1, wherein the first memory device is a semiconductor package assembled with a flash memory chip.

5. The flash drive as claimed in claim 4, wherein the first memory device is a TSOP (Thin Small Outline Package).

6. The flash drive as claimed in claim 1, wherein the first memory device is disposed on a bottom surface of the component section in side-by-side relationship with the controller.

7. The flash drive as claimed in claim 6, further comprising a second memory device disposed on a top surface of the component section, wherein the first and second memory device are TSOPs (Thin Small Outline Packages).

8. The flash drive as claimed in claim 6, further comprising an encapsulant formed over the bottom surface of the component section and over the bottom surface of the insertion section to encapsulate the first memory device and the controller.

9. The flash drive as claimed in claim 8, further comprising a second memory device disposed on a top surface of the component section.

10. The flash drive as claimed in claim 9, wherein the encapsulant is further formed on the top surface of the component section to encapsulate the second memory device with the contact fingers exposed.

11. The flash drive as claimed in claim 1, wherein the printed circuit board further has an extruded portion connected with one side of the component section opposite to the insertion section, a plurality of metal pads disposed on the extruded portion for accepting at least an indicating light.

12. The flash drive as claimed in claim 11, wherein the indicating light is an LED chip.

13. The flash drive as claimed in claim 1, further comprising at least a passive component disposed on the bottom surface of the insertion section to be located inside the USB connector.
